(19) United States
(12) Patent Application Publication
(10) Pub. No.: US 2026/0322643 A1
(43) Pub. Date: Oct. 15, 2026

(54) PROCEDURES TO HANDLE AN MBS SERVICE AREA THAT CANNOT BE COMPRISED WITHIN AN MB-SMF SERVICE AREA

(71) Applicant: Nokia Solutions and Networks Oy, Espoo (FI)

(72) Inventors: Horst Thomas BELLING, Munich (DE); Philippe GODIN, Massy (FR); Ugur Baran ELMALI, Munich (DE); Rajesh Babu NATARAJAN, Bangalore (IN); Bruno LANDAIS, Lannion (FR)

(21) Appl. No.: 19/483,682

(22) PCT Filed: May 7, 2024
(86) PCT No.: PCT/EP2024/062609

§ 371 Date: Nov. 12, 2025

(30) Foreign Application Priority Data
May 12, 2023 (IN) 202341033724

(51) Int. Cl. H04L 12/18; H04L 69/40

(52) U.S. Cl. CPC H04L 12/189; H04L 69/40

(57) ABSTRACT

Various example embodiments provide apparatuses, methods, computer programs, computer program products and computer-readable media for procedures to handle an MBS service area that cannot be comprised within an MB-SMF service area. For example, one example embodiment provides a method that includes generating a first multicast/broadcast session create or modification request indicating a first multicast/broadcast service area, transmitting the first multicast/broadcast session create or modification request to a second network node, receiving, from the second network node, a message including error information indicating that the first multicast/broadcast service area cannot be comprised within an area covered by a single multicast/broadcast session management function, generating a second multicast/broadcast session create or modification request with a reduced second service area compared to the first service area based on the error information, and transmitting the second multicast/broadcast session create or modification request to the second network node.

### TECHNICAL FIELD

Various example embodiments of the subject disclosure relate to apparatuses, methods, systems, computer programs, computer program products and computer-readable media for procedures to handle an MBS service area that cannot be comprised within an MB-SMF service area.

Abbreviations

| | |
|---|---|
| AF | Application Function |
| MBS | Multicast/Broadcast Service |
| MBSF | Multicast/Broadcast Service Function |
| MBSTF | Multicast/Broadcast Service Transport Function |
| MB-SMF | Multicast/Broadcast Session Management Function |
| MB-UPF | Multicast/Broadcast User Plane Function |
| NEF | Network Exposure Function |
| NRF | Network Repository Function |
| SMF | Session Management Function |
| TMGI | Temporary Mobile Group Identity |
| UE | User Equipment |

### BACKGROUND

Multicast and broadcast services are standardized in 3GPP TS 23.247. In MBS as defined in Release 17, there defined restrictions for deployments where SMFs and/or MB-SMFs only serve specific service areas. However, interaction between Multicast/Broadcast Service and support of deployments topologies with specific SMF Service Areas is not specified in this Release.

### SUMMARY

Various example embodiments of the subject disclosure aim to address at least part of the issues and/or problems and drawbacks described herein or otherwise apparent to a person skilled in the art in view of the subject disclosure.

In some example embodiments, apparatuses, methods, systems, computer programs, computer program products and computer-readable media are provided for procedures to handle a MBS service area that cannot be comprised within an MB-SMF service area.

According to some example embodiments, there is provided a method for use in a first network node, comprising:
generating a first multicast/broadcast session create or modification request indicating a first multicast/broadcast service area,
transmitting the first multicast/broadcast session create or modification request to a second network node,
receiving, from the second network node, a message including error information indicating that the first multicast/broadcast service area cannot be comprised within an area covered by a single multicast/broadcast session management function,
generating a second multicast/broadcast session create or modification request with a reduced second service area compared to the first service area based on the error information, and
transmitting the second multicast/broadcast session create or modification request to the second network node.

According to some example embodiments, there is provided a method for use in a second network node, comprising:
receiving a first multicast/broadcast session create or modification request generated by a first network node,
evaluating a multicast/broadcast service area indicated in the first multicast/broadcast session create or modification request,
if it is determined that the multicast/broadcast service area of the first multicast/broadcast session create or modification request cannot be comprised within an area covered by a single multicast/broadcast session management function, generating a message including error information indicating that the multicast/broadcast service area of the first multicast/broadcast session create or modification request cannot be comprised within the area covered by the single multicast/broadcast session management function, and
transmitting the message with error information to the first network node.

According to some example embodiments, there is provided an apparatus method for use in a first network node, comprising:
means for generating a first multicast/broadcast session create or modification request indicating a first multicast/broadcast service area,
means for transmitting the first multicast/broadcast session create or modification request to a second network node,
means for receiving, from the second network node, a message including error information indicating that the first multicast/broadcast service area cannot be comprised within an area covered by a single multicast/broadcast session management function,
means for generating a second multicast/broadcast session create or modification request with a reduced second service area compared to the first service area based on the error information, and
means for transmitting the second multicast/broadcast session create or modification request to the second network node

According to some example embodiments, there is provided an apparatus for use in a second network node, comprising:
means for receiving a first multicast/broadcast session create or modification request generated by a first network node,
means for evaluating a multicast/broadcast service area indicated in the first multicast/broadcast session create or modification request,
means for generating, if it is determined that the multicast/broadcast service area of the first multicast/broadcast session create or modification request cannot be comprised within an area covered by a single multicast/broadcast session management function, a message including error information indicating that the multicast/broadcast service area of the first multicast/broadcast session create or modification request cannot be comprised within the area covered by the single multicast/broadcast session management function, and
means for transmitting the message with error information to the first network node.

According to some example embodiments, there is provided a computer program product comprising code means adapted to produce steps of any of the methods as described above when loaded into the memory of a computer.

According to some example embodiments, there is provided a computer program product as defined above, wherein the computer program product comprises a computer-readable medium on which the software code portions are stored.

According to some example embodiments, there is provided a computer program product as defined above, wherein the program is directly loadable into an internal memory of the processing device.

According to some example embodiments, there is provided a computer readable medium storing a computer program as set out above.

According to some example embodiments, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Further aspects and features of the various example embodiments are set forth in the dependent claims.

### BRIEF DESCRIPTION OF THE DRAWINGS

Various example embodiments of the subject disclosure will now be described with reference to the accompanying drawings:

FIG. 1 (FIGS. 1A and 1B) is a signaling diagram illustrating an example of an MBS Session Creation without PCC;

FIG. 2 (FIGS. 2A and 2B) is a signaling diagram illustrating an example of an MBS Session Creation without PCC, according to some example embodiments of the subject disclosure;

FIG. 3 is a signaling diagram illustrating an example of an MBS session update without PCC;

FIG. 4 (FIGS. 4A and 4B) is a signaling diagram illustrating an example of an MBS session update without PCC, according to some example embodiments of the subject disclosure.

FIG. 5 is a flowchart illustrating an example of a method according to some example embodiments of the subject disclosure;

FIG. 6 is a flowchart illustrating another example of a method according to some example embodiments of the subject disclosure;

FIG. 7 is a block diagram illustrating an example of an apparatus according to some example embodiments of the subject disclosure;

FIG. 8 is a block diagram illustrating another example of an apparatus according to some example embodiments of the subject disclosure;

FIG. 9 is a block diagram illustrating another example of an apparatus according to some example embodiments of the subject disclosure;

FIG. 10 is a block diagram illustrating another example of an apparatus according to some example embodiments of the subject disclosure.

### DETAILED DESCRIPTION

It is noted that the subject disclosure and its various example embodiments may, in certain instances, refer to specifications being used as non-limiting examples for example network configurations and deployments. Namely, the subject disclosure and its various example embodiments may, for instance, be described in relation to 3GPP specifications, which is used as non-limiting examples for example network configurations and deployments. As such, the various example embodiments provided herein may specifically refer to terminology, which is directly related thereto. Such terminology, however, is only used in a non-limiting manner, and does naturally not limit the subject disclosure or its various example embodiments in any way. Rather, any other communication or communication related system deployment, etc. may also be utilized where compatible with any subject matter described herein.

Hereinafter, various embodiments and implementations of the subject disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

Various example embodiments of the subject disclosure generally relates to broadcast and multicast services, and more particularly to a case, where a MBS service area is expanded beyond a service area of a single MB-SMF.

As previously noted, multicast and broadcast services are standardized in 3GPP TS 23.247. In MBS as defined in Release 17, there defined restrictions for deployments where SMFs and/or MB-SMFs only serve specific service areas. However, interaction between Multicast/Broadcast Service and support of deployments topologies with specific SMF Service Areas is not specified in this Release.

That is, it is not defined how to handle an MBS session update where the MBS service area is expanded in such a manner that it is no longer covered by the service area of a single MB-SMF.

TS 23.247 describes that location-dependent services can be used as a partial solution to this issue. In this regard, the following is described in TS 23.247:

### 6.2.3 Location Dependent MBS Service

A location dependent MBS is identified by MBS Session ID, and provided in several MBS service areas. The location dependent MBS service enables distribution of different content data to different MBS service areas. The same MBS Session ID is used but a different Area Session ID is used for each MBS service area . . . .
Information about different MBS service areas for a location dependent MBS service may be provided by one or several AFs or may be configured. Different ingress points for location dependent points for the MBS session are supported for different MBS service area dependent content of the MBS session; different MB-SMFs and/or MB-UPF may be assigned for different MBS service areas in an MBS session. When the different MB-SMFs are assigned for different MBS service areas in an MBS session, the same TMGI is allocated for this MBS session.
The Area Session ID is allocated by MB-SMF in MBS Session creation procedure. MB-SMF allocates Area Session ID for each MBS services area which is unique within the MBS session. MB-SMF needs to further ensure there is no MBS service area overlapping with other MBS service areas that share the same MBS Session ID.
   NOTE 1: In this release, deployments topologies with specific SMF Service Areas are not supported, as a result, location dependent service using multicast communication is not supported when a UE moves outside its SMF service area.
   NOTE 2: For location dependent service provided in different MBS service areas within the same SMF service area, it is assumed that one MB-SMF is used for an MBS Session.

However, from the above, it still remains unclear how to handle an MBS session creation or modification with an MBS service area not covered by the MB-SMF service area of a single MB-SMF.

According to some example embodiments of the subject disclosure, there is introduced a method for procedures to handle an MBS service area that cannot be comprised within an MB-SMF service area.

According to some example embodiments of the subject disclosure, during MBS session creation or modification with an MBS service area not entirely covered by the MB-SMF service area of a single MB-SMF, the NEF, MBSF or MB-SMF can provide an error information indicating that the MBS service area cannot be comprised within a the MB-SMF service area of a single MB-SMF. This means that the NEF or MBSF cannot find any MB-SMF for which the requested MBS session service area can be comprised in the MB-SMF service area (only as an example, this applies to a case where the MBS service area is larger than the MB-SMF service area of a single MB-SMF) and may additionally provide information about an acceptable MBS service area of one or more MB-SMF service areas. The AF can then reduce the MBS service area and/or establish additional service area specific area sessions of a location-dependent service which would involve multiple MB-SMFs.

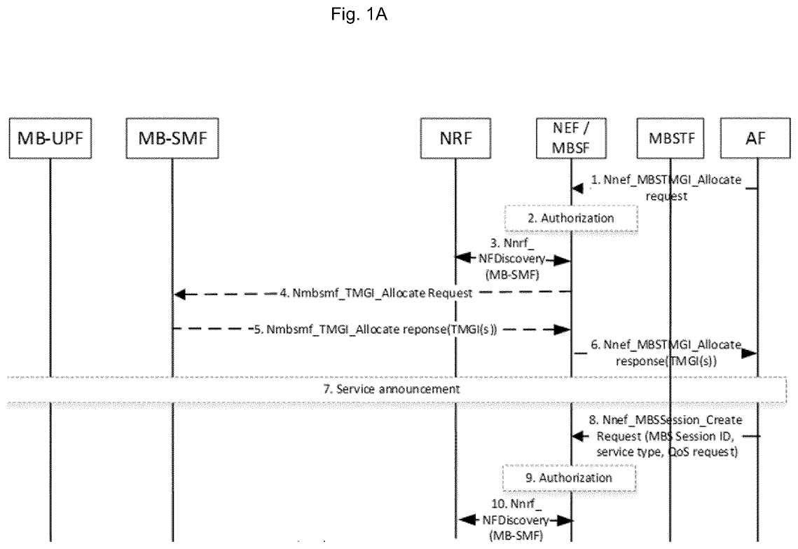

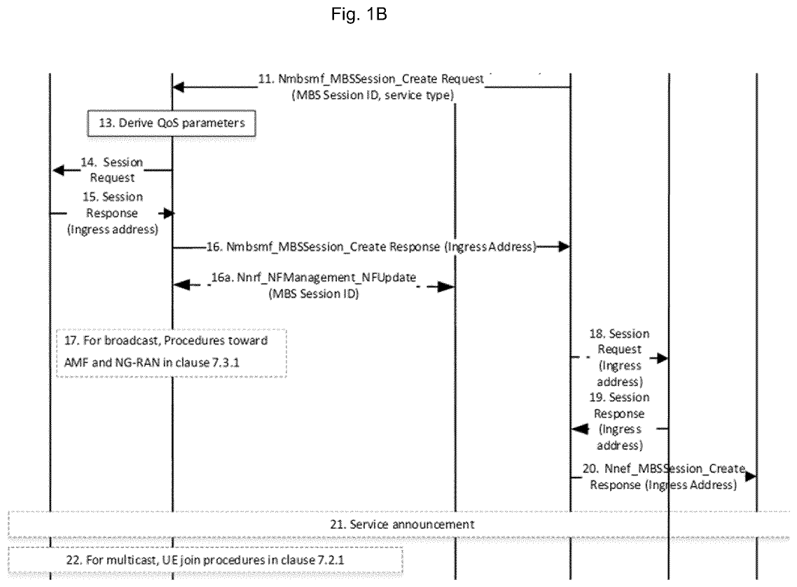

FIG. 1 (FIGS. 1A and 1B) is a signaling diagram illustrating an example of an MBS Session Creation without PCC, as described in TS 23.247. The following description of FIG. 1 is taken from TS 23.247, section 7.1.1.2.

FIG. 1 shows a “NEF/MBSF”, but as detailed in Annex A of TS 23.247, there can be different related network deployment involving either only NEF, or MBSF, or both. The interactions between “NEF/MBSF” and MB-SMF, PCF, BSF and NRF depicted in the call flows apply for NEF, MBSF or a combined NEF and MBSF, depending on network deployment. They may also apply for an AF in the trusted domain where NEF is not mandated.

However, the interactions between AF and “NEF/MBSF” depicted in the call flow only apply for the NEF.

Interactions between AF and MBSF based on the MB2 interface follow TS 23.468 (see Annex C).

Interactions between AF and MBSF based on the xMB interface follow TS 26.348 (see Annex C).

Services offered by the MBSF and related interactions based on that service between MBSF and AF or NEF (if MBSF and NEF are split as shown in configuration 2) are specified in TS 26.502.

Detailed interactions between the MBSF or NEF and the MBSTF are specified in TS 26.502.

Steps 1 to 6 are optional and only applicable if TMGI is used as MBS Session ID and required to be pre-allocated.
1. AF sends Nnef_MBSTMGI_Allocate Request (TMGI number, [MBS service area]) message to NEF/MBSF to request allocation of a TMGI(s) to identify new MBS session(s). The MBS service area indicates the possible service area for those TMGI(s) to be allocated, which may be needed for local MBS.
NOTE 1: Depending on the network deployment and use case, MB-SMF may receive requests from AF directly, or via NEF, or via MBSF, or via NEF and MBSF.
Editor's note: Updates to TMGI allocation for resource sharing across multiple broadcast MBS Sessions during network sharing based on configured TMGI mapping in NG-RAN (see clause 6.17) are FFS.
2. NEF/MBSF checks authorization of AF. If geographical area information or civic address information was provided by the AF as MBS service area, NEF/MBSF performs the translation.
NOTE 2: NEF is not required if AF is in trusted domain.
3. NEF/MBSF discovers and selects an MB-SMF using NRF or based on local configuration, possibly based on MBS service area.
4. NEF/MBSF sends an Nmbsmf_TMGI_Allocate Request (TMGI number) message to the MB-SMF.
5. MB-SMF allocates TMGI(s) and returns the TMGI(s) to the NEF/MBSF via the Nmbsmf_TMGI_Allocate response (TMGI(s), expiration time).
6. The NEF or MBSF responds to the AF by sending an Nnef_MBSTMGI_Allocate Response (TMGI(s), expiration time).
7. The AF may perform a Service Announcement towards UEs. The AF informs UEs about MBS Session information with MBS Session ID, e.g. TMGI, SSM, and possibly other information e.g. MBS service area, session description information, etc.
   The MBS service area information can be Cell ID list, TAI list, geographical area information or civic address information. Amongst them, Cell ID list and TAI list shall only be used by AFs who reside in trust domain, and when the AFs are aware of such information.
   The UE needs to be aware if the service is broadcast or multicast to decide if JOIN is to be performed.
8. AF of content provider may provide description for an MBS session (possibly providing information for a previously allocated TMGI to NEF via a Nnef_MBSSession_Create request ([MBS Session ID], MBS service type, MBS Service Information, [TMGI allocation request], [MBS service area], [Any UE indication], [start and end time of the MBS session], [MBS session state], [ingress transport address request indication], [Request for location-dependent session], [FSA ID(s)], [Associated Session Identifier]). If step 1-6 has not been executed before, the AF may provide an MBS Session ID containing an SSM or it may request that the network allocates an MBS Session ID (i.e., TMGI). The AF provides the MBS service type (i.e. either multicast service or broadcast service) and MBS Service Information (as defined in clause 6.14). The AF may provide the “Any UE indication” (indicating whether a multicast MBS session is “open to any UEs”), MBS service area, start and end time of the MBS session and MBS session state (active/inactive). In addition, the AF request may also indicate that the allocation of an ingress transport address is requested and that the AF request is for a location dependent MBS service.
   If geographical area information or civic address information was provided by the AF as MBS service area, NEF/MBSF translates the MBS service area to Cell ID list or TAI list.
   For broadcast communication, the AF may determine MBS FSA ID(s) for the Broadcast MBS session based on business agreements and include them in the description of the MBS session.
   For broadcast communication, to support resource sharing across MBS Sessions during network sharing (see clause 6.17), the AF may include Associated Session Identifier in this step to enable NG-RAN to identify the broadcast MBS sessions from multiple CNs delivering the same content.
NOTE 3: The same QoS requirements are assumed to be provided by the AF for the broadcast MBS Sessions via multiple CNs delivering the same content.
NOTE 4: MBS session state is applicable for multicast MBS Session.
9. NEF/MBSF checks authorization of content provider.
10. NEF/MBSF discovers MB-SMF candidates and selects MB-SMF as ingress control node, possibly based on MBS service area. If a TMGI is included in step 8, NEF/MBSF finds MB-SMF based on that TMGI.
11. NEF/MBSF sends Nmbsmf_MBSSession_Create Request ([MBS Session ID], MBS service type, [TMGI allocation request], MBS Service Information (as defined in clause 6.14), [MBS service area], [Any UE indication], [start and end time of the MBS session], [MBS session state], [ingress transport address request indication], [FSA ID(s)], [Associated Session Identifier], [multicast session security context]) to MB-SMF, to request MB-SMF to reserve ingress resources for an MBS distribution session. The NEF/MBSF forwards all parameters it has received from the AF in step 8. If the MBSF decides to insert an MBSTF into the user plane for the MBS session, it also indicates that the allocation of an ingress transport address is requested even if this was not requested in step 8. The request also includes the Any UE indication if provided in step 8. If the MBSF acts as the MBS security function for multicast as defined in TS 33.501 [20], it provides a multicast session security context for the MBS session.
   If requested to do so, or if a source specific multicast is provided as MBS Session ID in step 11, the MB-SMF allocates a TMGI.
   For broadcast communication, if no MBS FSA ID(s) have been received, the MB-SMF selects MBS FSA ID(s) for the Broadcast MBS session based on local configuration.
12. Void.
13. The MB-SMF derives the required QoS parameters locally based on the MBS Service Information.
14. MB-SMF selects the MB-UPF. If the allocation of an ingress transport address was requested in step 11, the MB-SMF requests the MB-UPF to reserve user plane ingress resources. If multicast transport of the MBS data towards RAN nodes is to be used, the MB-SMF also request the MB-UPF to reserve for the outgoing data a tunnel endpoint and the related identifiers (source IP address, SSM and GTP Tunnel ID) and to forward data received at the user plane ingress resource using that tunnel endpoint.
   If the allocation of an ingress transport address was not requested in step 11, the MB-SMF provides the SSM received as MBS Session ID to the MB-UPF and requests the MB-UPF to join the corresponding multicast tree from the content provider. The MB-SMF may also defer the configuration to join the corresponding multicast tree e.g. based on information that the session is inactive, service requirements and MBS start/end time until receiving the first query for the MBS session as part of the establishment procedure in clause 7.2.1.3, or until receiving a request to activate the MBS session via the MBS Session Update procedure in clause 7.1.1.6.
15. If requested, MB-UPF selects an ingress address (IP address and port) and a tunnel endpoint for the outgoing data and provides it to MB-SMF.
16. MB-SMF indicates the possibly allocated ingress address to the NEF/MBSF. MB-SMF may include TMGI if it is allocated in step 11. For broadcast communication, the MB-SMF includes any MBS FSA ID(s) selected in step 11. It also indicates the success or failure of reserving transmission resources.
16a. If a source specific multicast address is provided as MBS Session ID in step 11, the MB-SMF updates its NF profile at the NRF with the serving MBS Session ID. If an MBS service area was received in step 11, the MB-SMF updates its NF profile at the NRF with that information.
NOTE 3: If TMGI is used to represent an MBS Session, MB-SMF does not need to update NRF if the TMGI range(s) supported by an MB-SMF is already included in the MB-SMF profile when MB-SMF register itself into NRF.
17. For broadcast communication, the MB-SMF continues the procedure towards the AMF and NG-RAN as specified in clause 7.3.1 to request the allocation of resources to for the transmission of the broadcast session.
18. [Optional] If the MBSF decides to use an MBSTF, the NEF/MBSF provides the ingress address received in step 16 towards the MBSTF as DL destination. If the allocation of an ingress transport address was requested in step 8, the MBSF requests the MBSTF to allocate the user plane ingress resources. If the allocation of an ingress transport address was not requested in step 8, the MBSF provides the SSM received as Multicast session ID in step 8 and requests the MBSTF to join the corresponding multicast tree from the content provider.
19. [Conditional on step 19] If requested, the MBSTF selects an ingress address (IP address and port) and provides it to NEF/MBSF.
20. The NEF/MBSF-C indicates the possibly allocated ingress address and other parameters (e.g. TMGI) to the AF via an Nnef_MBSSession_Create response ([TMGI], [Allocated ingress address])). If MBS Session ID is not provided in step 8, or the MBS Session ID is SSM, the NEF/MBSF provides the allocated TMGI. If AF requested the allocation of an ingress transport address, the message also includes the allocated ingress address. For broadcast communication, the message also includes any MBS FSA ID(s) received in step 17.
21. Same as step 7. The AF may also perform a service announcement at this stage.
22. For multicast communication, depending on configuration UEs can join the MBS Session as specified in clause 7.2.1.

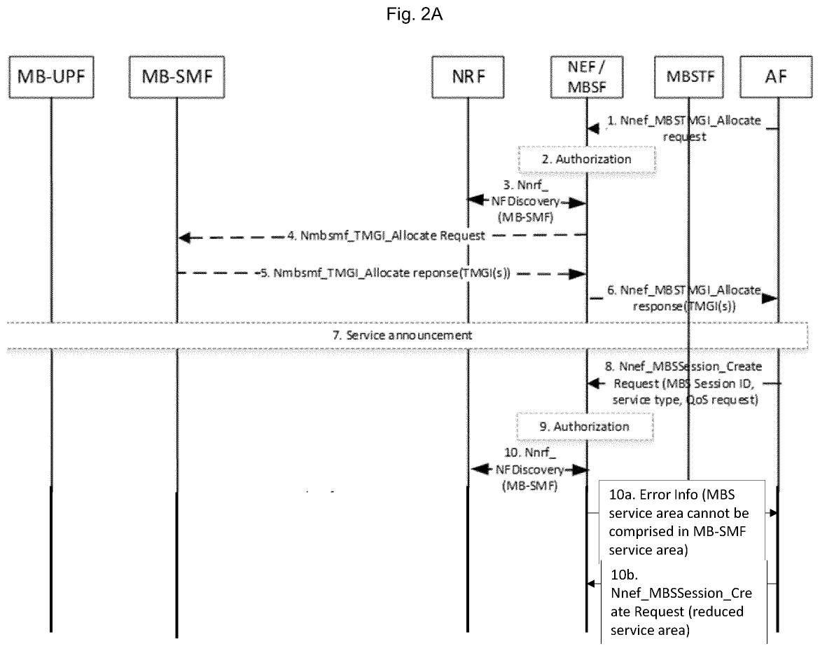

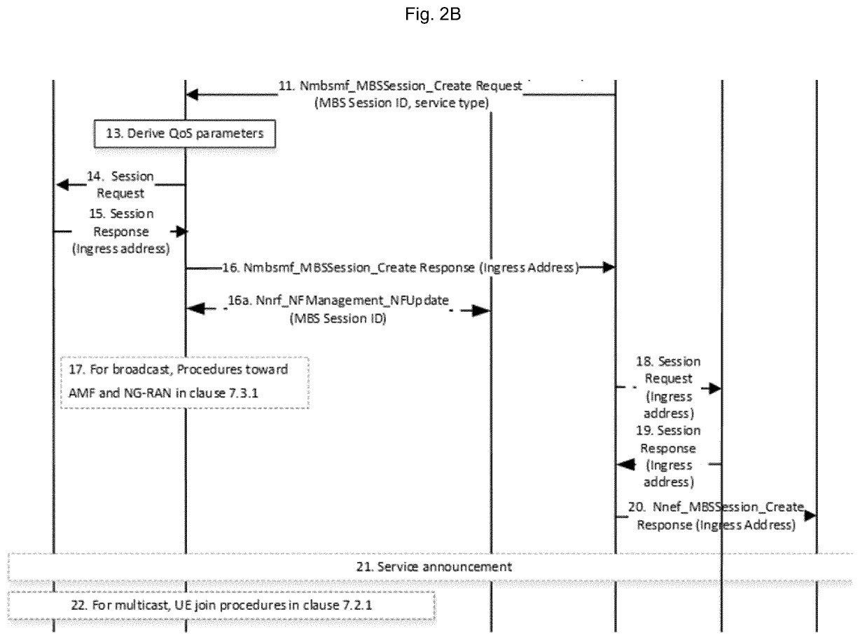

FIG. 2 (FIGS. 2A and 2B) is a signaling diagram illustrating an example of an MBS Session Creation without PCC, according to some example embodiments of the subject disclosure. By way of illustrative example, the steps in FIG. 2 may correspond to the steps described with respect to FIG. 1.

According to some example embodiments of the subject disclosure, steps 10 and 11 can be modified as follows.

As already mentioned above, the NEF/MBSF discovers MB-SMF candidates and selects MB-SMF as ingress control node, possibly based on MBS service area.

According to some example embodiments of the subject disclosure, the NEF/MBSF requests information about multicast/broadcast session management functions from an NRF, and obtains information about at least one multicast/broadcast session management function from the NRF comprising for each multicast/broadcast session management function the area covered by the multicast/broadcast session management function.

Additionally, according to some example embodiments of the subject disclosure, if the MBS service area received in step 8 is not covered by the MB-SMF service area of a single MB-SMF, in a new step 10a, the NEF/MBSF rejects the MBS session creation with an new error information indicating that the MBS service area cannot be comprised within the MB-SMF service area of a single MB-SMF (i.e. cannot be comprised within an area covered by a single multicast/broadcast session management function; this applies, for example, to a case where the MBS service area is larger than the MB-SMF service area of a single MB-SMF) and may additionally provide new information about one or more acceptable MBS service area(s) in the error response. The error information comprises information about an acceptable multicast/broadcast service area and the information about the acceptable multicast/broadcast service area comprises at least one of the following:
The parts of the MBS service area covered by a single MB-SMF service area (e.g., the parts of the first multicast/broadcast service area covered by an area covered by a single multicast/broadcast session management function),
A single MB-SMF service area that is covering the largest part of the MBS service area (e.g., an area covered by a single multicast/broadcast session management function),
A list of MB-SMF service areas that together are covering the MBS service area (e.g., a list of areas, each covered by a single multicast/broadcast session management function, that together are covering the first multicast/broadcast service area), or
A list of all MB-SMF service areas (e.g., a list of areas, each covered by a single multicast/broadcast session management function, for all multicast/broadcast session management functions in a network).

In a new step 10b, the AF can then reduce the MBS service area in a new MBS session creation request and/or establish additional service area specific sub sessions (area sessions of the MBS session) of a location-dependent service. That is, the AF generates a second multicast/broadcast session create or modification request with a reduced second service area compared to the first service area based on the error information. The reduced second service area comprises an area that is covered by a single multicast/broadcast session management function.

Further, the AF can generate a third multicast/broadcast session create request with a reduced third service area compared to the first service area based on the error information, and transmit the third multicast/broadcast session create request to the network exposure function, or a multicast/broadcast service function. The reduced third service area comprises an area that is covered by a single multicast/broadcast session management function. The second multicast/broadcast session create or modification request and the third multicast/broadcast session create request comprise the same multicast/broadcast session identifier, and the third multicast/broadcast session create request comprises an indication that the multicast/broadcast session is a location-dependent multicast/broadcast session, and if the second multicast/broadcast session create or modification request is a create request, the second multicast/broadcast session create or modification request comprises an indication that the multicast/broadcast session is a location-dependent multicast/broadcast session.

Additionally, the AF can transmit the third multicast/broadcast session create request to another network exposure function or multicast/broadcast service function.

The AF can also send data via unicast delivery to UEs outside the reduced MBS service area.

Alternatively, also some modifications to step 11 are proposed according to some example embodiments of the subject disclosure (not shown in FIG. 2).

The addition to this step applies if the AF interacts directly with the MB-SMF during the MBS session creation (i.e. there is no NEF or MBSF forwarding the MBS session creation request). That is, the Nnef_MBSSession_Create Request is directly transmitted from the AF to the MB-SMF without the NEF or MBSF in between.

If the MBS service area is not covered by the MB-SMF service area of the MB-SMF, the MB-SMF rejects the MBS session creation with an new error information indicating that the MBS service area cannot be comprised within the MB-SMF service area of a single MB-SMF (e.g., cannot be comprised within an area covered by a single multicast/broadcast session management function; this applies, for example, to a case where the MBS service area is larger than the MB-SMF service area of a single MB-SMF) and may additionally newly provide information about an acceptable MBS service area (as described above) in the error response. The AF handles the error response as described above.

In a similar manner as mentioned above, the error information comprises information about an acceptable multicast/broadcast service area and the information about the acceptable multicast/broadcast service area comprises at least one of the following:
The parts of the MBS service area covered by a single MB-SMF service area (e.g., the parts of the first multicast/broadcast service area covered by an area covered by a single multicast/broadcast session management function),
A single MB-SMF service area that is covering the largest part of the MBS service area (e.g., an area covered by a single multicast/broadcast session management function),
A list of MB-SMF service areas that together are covering the MBS service area (e.g., a list of areas, each covered by a single multicast/broadcast session management function, that together are covering the first multicast/broadcast service area), or
A list of all MB-SMF service areas (e.g., a list of areas, each covered by a single multicast/broadcast session management function, for all multicast/broadcast session management functions in a network).

Then, the AF can then reduce the MBS service area in a new MBS session creation request and/or establish additional service area specific sub sessions (area sessions of the MBS session) of a location-dependent service. That is, the AF generates a second multicast/broadcast session create or modification request with a reduced second service area compared to the first service area based on the error information. The reduced second service area comprises an area that is covered by a single multicast/broadcast session management function.

Further, the AF can generate a third multicast/broadcast session create or modification request with a reduced second service area compared to the first service area based on the error information, and transmit the third multicast/broadcast session create or modification request directly to the multicast/broadcast session management function. Additionally, the AF can transmit the third multicast/broadcast session create or modification request directly to another multicast/broadcast session management function.

The AF can also send data via unicast delivery to one or more UEs outside the reduced MBS service area.

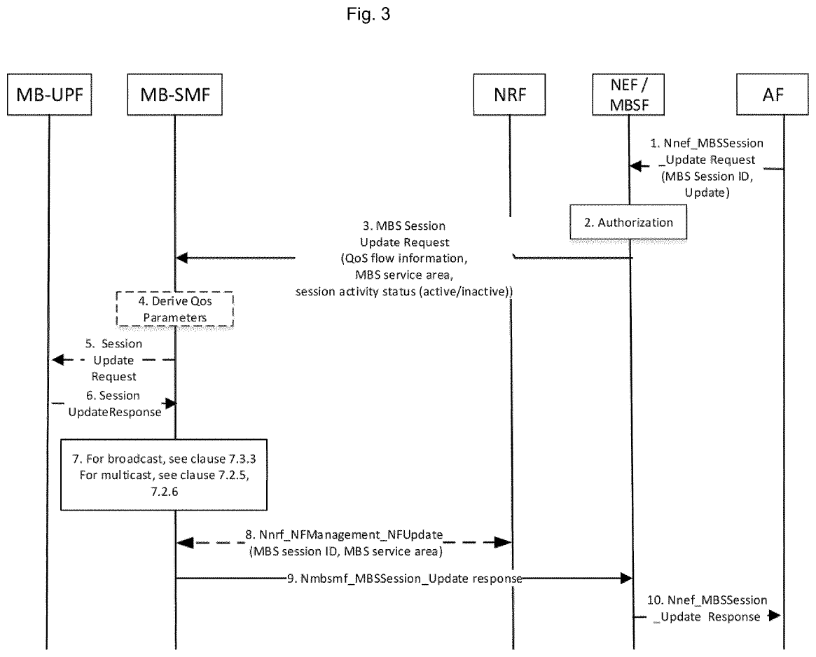

FIG. 3 is a signaling diagram illustrating an example of an MBS session update without PCC as defined in TS 23.247. The following description of FIG. 3 is taken from TS 23.247, section 7.1.1.6.
1. AF of content provider initiates MBS Session Update to a NEF/MBSF, e.g. to update MBS service area and/or update MBS Service Information (as defined in clause 6.14), or to activate or deactivate an MBS session. AF may provide updated information for an MBS session (identified by MBS session ID) by sending a Nnef_MBSSession_Update Request (MBS Session ID, [MBS Service Information], [MBS service area], [MBS session state (active/inactive)]).
   If geographical area information or civic address information was provided by the AF as MBS service area, NEF/MBSF translates the MBS service area to Cell ID list or TAI list.
2. NEF checks authorization of AF.
3. NEF/MBSF sends Nmbsmf_MBSSession_Update Request to MB-SMF forwarding the updated information received from the AF in step 1. If the MBSF acts as the MBS security function for multicast as defined in TS 33.501 [20], it may provide an updated multicast session security context for the MBS session in the Nmbsmf_MBSSession_Update Request.
4. The MB-SMF derives any updated QoS parameters locally under consideration of the updated MBS Service Information. This may lead to addition of new MBS QoS Flow(s), removal of existing MBS QoS Flow(s) or update of existing MBS QoS Flow(s).
5-6. MB-SMF may need to update MB-UPF, e.g. if new MBS QoS Flow is to be created, or existing MBS QoS Flow is to be deleted.
7. For broadcast communication, the MB-SMF continues the procedure towards the AMF and NG-RAN as specified in clause 7.3.3. For multicast communication, the MB-SMF continues the procedure towards the AMF and NG-RAN as specified in clause 7.2.5 (for service activation/deactivation), 7.2.6 (for QoS updates and service area updates).
8. If an MBS service area is being updated, the MB-SMF stores the new service area in its profile at the NRF.
9. MB-SMF responds to the NEF/MBSF with a Nmbsmf_MBSSession_Update Response.
10. NEF/MBSF responds to the AF with a Nnef_MBSSession_Update Response.

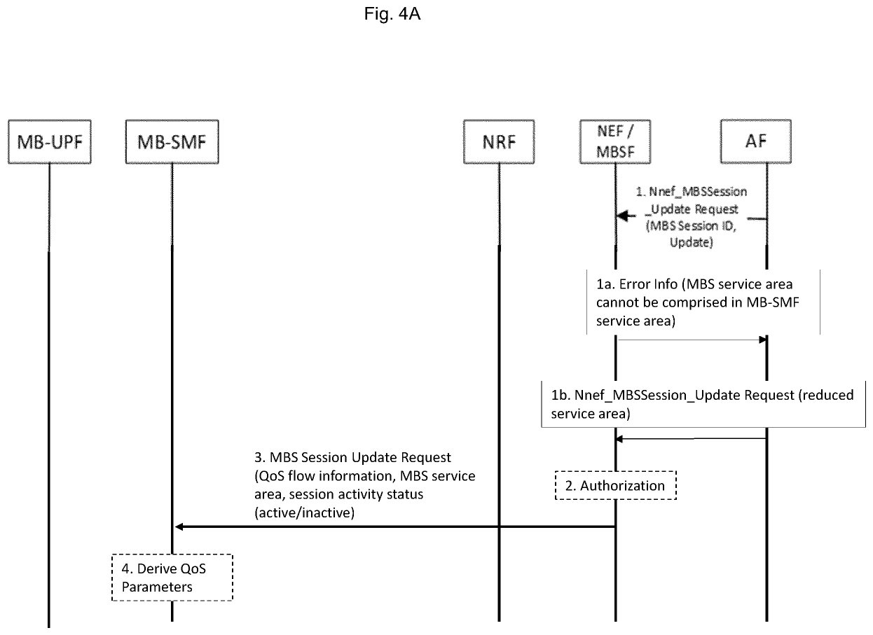

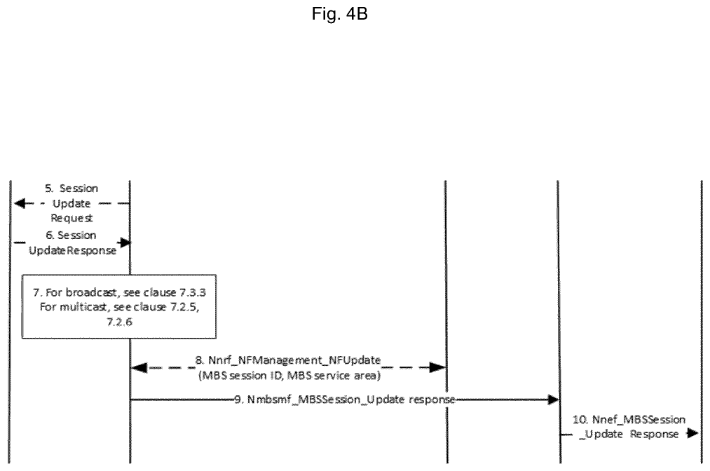

FIG. 4 (FIGS. 4A and 4B) is a signaling diagram illustrating an example of an MBS session update without PCC, according to some example embodiments of the subject disclosure. By way of illustrative example, the steps in FIG. 4 may correspond to the steps described with respect to FIG. 3.

According to some example embodiments of the subject disclosure, steps 1 and 3 are modified as follows.

In a similar manner as already described above with respect to the MBS Session Creation, in step 1a, if the updated MBS service area received in the MBS session update request is not covered by the MB-SMF service area of the MB-SMF assigned to this MBS session (or location-dependent area subsession of the MBS session), the NEF/MBSF rejects the MBS session update with an new error information indicating that the MBS service area cannot be comprised within the MB-SMF service area of a single MB-SMF and may additinally provide new information about an acceptable MBS service area in the error response. The error information includes the same information as already mentioned above with respect to FIG. 2.

In step 1b, the AF can then reduce the MBS service area in a new MBS session creation request and/or establish additional service area specific sub sessions (area sessions) of a location-dependent service. The AF can also send data via unicast delivery to UEs outside the reduced MBS service area.

Further, also some modifications to step 3 are proposed according to some example embodiments of the subject disclosure (not shown in FIG. 4A).

If the AF interacts directly with the MB-SMF during the MBS session creation (e.g., there is no NEF or MBSF forwarding the MBS session creation request), that is, the Nnef_MBSSession_Create Request is directly transmitted from the AF to the MB-SMF without the NEF or MBSF in between, if the MBS service area is not covered by the MB-SMF service area of the MB-SMF, the MB-SMF rejects the MBS session update with an new error information indicating that the MBS service area cannot be comprised within the MB-SMF service area of a single MB-SMF and and may additionally provide information about an acceptable MBS service area (as described above) in the error response. The AF handles the error response as already described above.

The detailed processing in steps 1a, 1b and 3 in FIG. 4A is similar to the processing in steps 10a, 10b and 11 as described above with respect to FIG. 2A and will therefore not be repeated here.

In view of the above, according to some example embodiments of the subject disclosure, the AF is notified about an MBS service area that cannot be comprised within a service area of an MB-SMF using an error message, for example, because the MBS service area is larger than the service area of an MB-SMF.

Based on the notification, the AF can either reduce the MBS service area, select multiple MB-SMFs or use unicast for UEs outside the single MB-SMF service area.

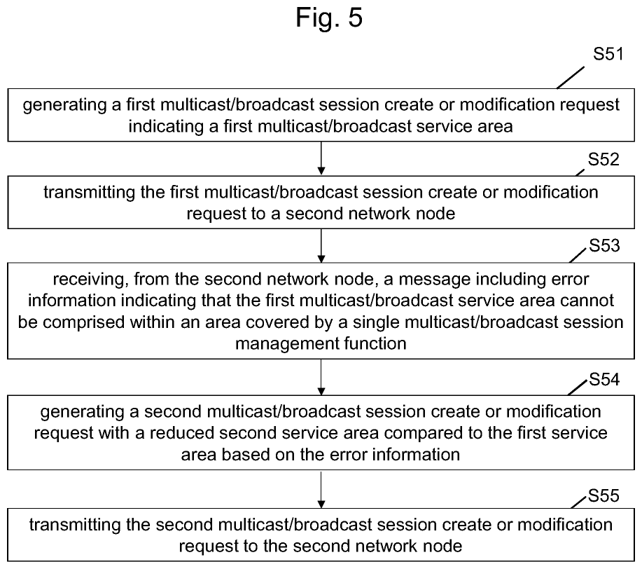

In the following, a more general description of various example embodiments of the subject disclosure is made with respect to FIGS. 5 to 10.

FIG. 5 is a flowchart illustrating an example of a method according to some example embodiments of the subject disclosure.

According to example embodiments of the subject disclosure, the method may be implemented in or may be part of a first network node, like an application function, AF, or the like. The method comprises generating, in step S51, a first multicast/broadcast session create or modification request indicating a first multicast/broadcast service area, transmitting, in step S52, the first multicast/broadcast session create or modification request to a second network node, receiving, in step S53, from the second network node, a message including error information indicating that the first multicast/broadcast service area cannot be comprised within an area covered by a single multicast/broadcast session management function, generating, in step S54, a second multicast/broadcast session create or modification request with a reduced second service area compared to the first service area based on the error information, and transmitting, in step S55, the second multicast/broadcast session create or modification request to the second network node.

According to some example embodiments of the subject disclosure, the error information comprises information about an acceptable multicast/broadcast service area.

According to some example embodiments of the subject disclosure, the information about an acceptable multicast/broadcast service area comprises at least one of:
parts of the first multicast/broadcast service area covered by an area covered by a single multicast/broadcast session management function,
an area covered by a single multicast/broadcast session management function,
a list of areas, each covered by a single multicast/broadcast session management function, that together are covering the first multicast/broadcast service area, or
a list of areas, each covered by a single multicast/broadcast session management function, for all multicast/broadcast session management functions in a network.

According to some example embodiments of the subject disclosure, the reduced second service area comprises an area that is covered by a single multicast/broadcast session management function.

According to some example embodiments of the subject disclosure, the method further comprises generating a third multicast/broadcast session create request with a reduced third service area compared to the first service area based on the error information, and transmitting the third multicast/broadcast session create request to the second network function or a third network function.

According to some example embodiments of the subject disclosure, the reduced third service area comprises an area that is covered by a single multicast/broadcast session management function.

According to some example embodiments of the subject disclosure, the second multicast/broadcast session create or modification request and the third multicast/broadcast session create request comprise the same multicast/broadcast session identifier, and the third multicast/broadcast session create request comprise an indication that the multicast/broadcast session is a location-dependent multicast/broadcast session, and if the second multicast/broadcast session create or modification request is a create request, it comprises an indication that the multicast/broadcast session is a location-dependent multicast/broadcast session.

According to some example embodiments of the subject disclosure, the third network node is a network exposure function, a multicast/broadcast service function or a multicast/broadcast session management function.

According to some example embodiments of the subject disclosure, the method further comprises sending data to at least one user equipment, which is located outside the area covered by the single multicast/broadcast session management function, via unicast delivery.

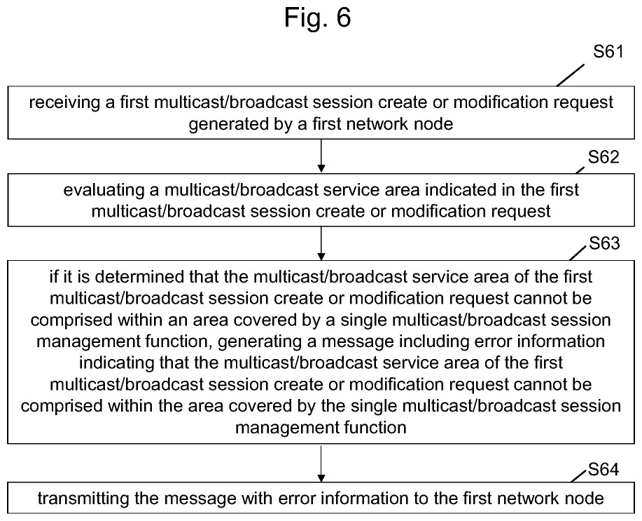

FIG. 6 is a flowchart illustrating another example of a method according to some example embodiments of the subject disclosure.

According to some example embodiments of the subject disclosure, the method may be implemented in or may be part of a second network node, like a network exposure function, a multicast/broadcast service function or a multicast/broadcast session management function, or the like. The method comprises receiving, in step S61, a first multicast/broadcast session create or modification request generated by a first network node, evaluating, in step S62, a multicast/broadcast service area indicated in the first multicast/broadcast session create or modification request, if it is determined that the multicast/broadcast service area of the first multicast/broadcast session create or modification request cannot be comprised within an area covered by a single multicast/broadcast session management function, generating, in step S63, a message including error information indicating that the multicast/broadcast service area of the first multicast/broadcast session create or modification request cannot be comprised within the area covered by the single multicast/broadcast session management function, and transmitting, in step S64, the message with error information to the first network node.

According to some example embodiments of the subject disclosure, the error information comprises information about an acceptable multicast/broadcast service area.

According to some example embodiments of the subject disclosure, the information about an acceptable multicast/broadcast service area comprises at least one of:
the parts of the first multicast/broadcast service area covered by an area covered by the multicast/broadcast session management function,
the area covered by the multicast/broadcast session management function
a list of areas, each covered by a single multicast/broadcast session management function, that together are covering the first multicast/broadcast service area, or
a list of areas, each covered by a single multicast/broadcast session management function, for all multicast/broadcast session management functions in a network.

According to some example embodiments of the subject disclosure, the method further comprises requesting information about multicast/broadcast session management functions from a fourth network function, and obtaining information about at least one multicast/broadcast session management function from the fourth network function comprising for each multicast/broadcast session management function the area covered by the multicast/broadcast session management function.

According to some example embodiments of the subject disclosure, the fourth network node may be implemented by a network repository function.

According to some example embodiments of the subject disclosure, the first network node is an application function, and the second network node is a network exposure function, a multicast/broadcast service function or a multicast/broadcast session management function.

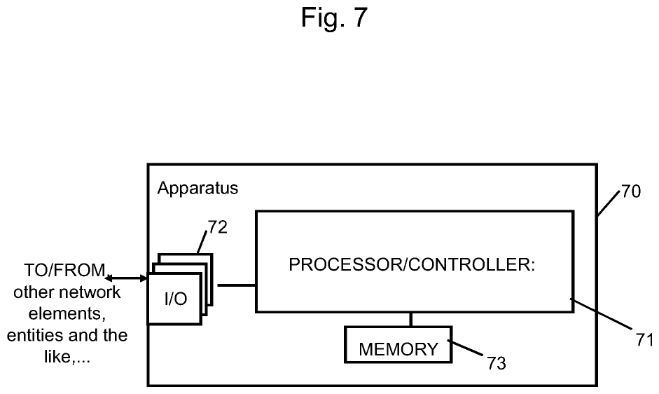

FIG. 7 is a block diagram illustrating an example of an apparatus according to some example embodiments of the subject disclosure.

In FIG. 7, a block circuit diagram illustrating a configuration of an apparatus 70 is shown, which is configured to implement the above described various example embodiments of the subject disclosure. It is noted that the apparatus 70 shown in FIG. 7 may comprise several further elements or functions besides those described herein below, which are omitted herein for the sake of simplicity as they are not essential for understanding the invention. Furthermore, the apparatus may be also another device having a similar function, such as a chipset, a chip, a module etc., which can also be part of an apparatus or attached as a separate element to the apparatus, or the like.

The apparatus 70 may comprise a processing function or processor 71, such as a CPU or the like, which executes instructions given by programs or the like. The processor 71 may comprise one or more processing portions dedicated to specific processing as described below, or the processing may be run in a single processor. Portions for executing such specific processing may be also provided as discrete elements or within one or further processors or processing portions, such as in one physical processor like a CPU or in several physical entities, for example. Reference sign 72 denotes transceiver or input/output (I/O) units (interfaces) connected to the processor 71. The I/O units 72 may be used for communicating with one or more other network elements, entities, terminals or the like. The I/O units 72 may be a combined unit comprising communication equipment towards several network elements, or may comprise a distributed structure with a plurality of different interfaces for different network elements. The apparatus 70 further comprises at least one memory 73 usable, for example, for storing data and programs to be executed by the processor 71 and/or as a working storage of the processor 71.

The processor 71 is configured to execute processing related to the above-described example embodiments.

the apparatus 70 may be implemented in or may be part of a first network node, like an application function, or the like and may be configured to perform processing as described in connection with FIG. 5.

Thus, according to some example embodiments of the subject disclosure, there is provided an apparatus 70 for use in a first network node, comprising at least one processor 71, and at least one memory 73 for storing instructions to be executed by the processor 71, wherein the at least one memory 73 and the instructions are configured to, with the at least one processor 71, cause the apparatus 70 at least to perform generating a first multicast/broadcast session create or modification request indicating a first multicast/broadcast service area, transmitting the first multicast/broadcast session create or modification request to a second network node, receiving, from the second network node, a message including error information indicating that the first multicast/broadcast service area cannot be comprised within an area covered by a single multicast/broadcast session management function, generating a second multicast/broadcast session create or modification request with a reduced second service area compared to the first service area based on the error information, and transmitting the second multicast/broadcast session create or modification request to the second network node.

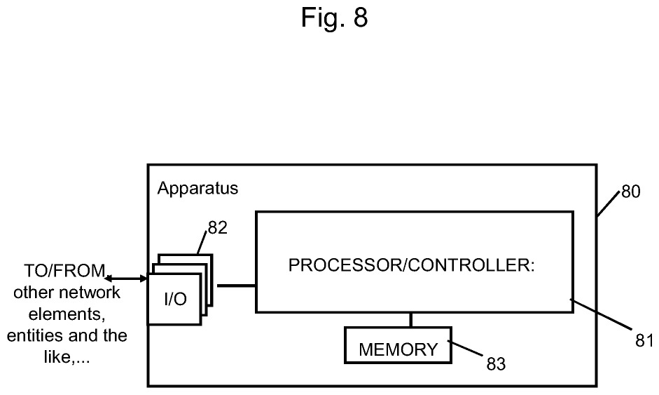

FIG. 8 is a block diagram illustrating another example of an apparatus according to some example embodiments of the subject disclosure. The apparatus illustrated in FIG. 8 substantially has the same structural components and arrangement than the apparatus of FIG. 7, and hence, a description thereof will not be repeated.

The processor 81 is configured to execute processing related to the above-described example embodiments.

In particular, the apparatus 80 may be implemented in or may be part of a second network node, like a network exposure function, a multicast/broadcast service function or a multicast/broadcast session management function, or the like, and may be configured to perform processing as described in connection with FIG. 6. Thus, according to some example embodiments of the subject disclosure, there is provided an apparatus 80 for use in a second network node, comprising at least one processor 81, and at least one memory 83 for storing instructions to be executed by the processor 81, wherein the at least one memory 83 and the instructions are configured to, with the at least one processor 81, cause the apparatus 80 at least to perform receiving a first multicast/broadcast session create or modification request generated by a first network node, evaluating a multicast/broadcast service area indicated in the first multicast/broadcast session create or modification request, if it is determined that the multicast/broadcast service area of the first multicast/broadcast session create or modification request cannot be comprised within an area covered by a single multicast/broadcast session management function, generating a message including error information indicating that the multicast/broadcast service area of the first multicast/broadcast session create or modification request cannot be comprised within the area covered by the single multicast/broadcast session management function, and transmitting the message with error information to the first network node.

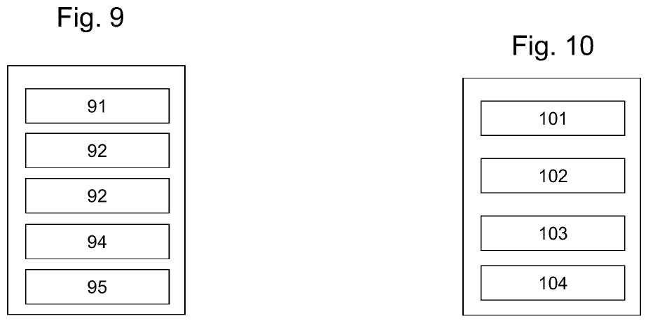

Further, some example embodiments of the subject disclosure may be implemented by an apparatus for a first network node comprising means for performing the above-described processing, as shown in FIG. 9.

That is, according to some example embodiments of the subject disclosure, as shown in FIG. 9, the apparatus for use in a first network node comprises means 91 for generating a first multicast/broadcast session create or modification request indicating a first multicast/broadcast service area, means 92 transmitting the first multicast/broadcast session create or modification request to a second network node, means 93 for receiving, from the second network node, a message including error information indicating that the first multicast/broadcast service area cannot be comprised within an area covered by a single multicast/broadcast session management function, means 94 for generating a second multicast/broadcast session create or modification request with a reduced second service area compared to the first service area based on the error information, and means 95 for transmitting the second multicast/broadcast session create or modification request to the second network node.

Further, some example embodiments of the subject disclosure may be implemented by an apparatus for a second network node comprising means for performing the above-described processing, as shown in FIG. 10.

That is, according to some example embodiments of the subject disclosure, as shown in FIG. 10, the apparatus for use in a second network node comprises means 101 for receiving a first multicast/broadcast session create or modification request generated by a first network node, means 102 for evaluating a multicast/broadcast service area indicated in the first multicast/broadcast session create or modification request, means 103 for generating, if it is determined that the multicast/broadcast service area of the first multicast/broadcast session create or modification request cannot be comprised within an area covered by a single multicast/broadcast session management function, a message including error information indicating that the multicast/broadcast service area of the first multicast/broadcast session create or modification request cannot be comprised within the area covered by the single multicast/broadcast session management function, and means 104 for transmitting the message with error information to the first network node.

Additionally, according to some example embodiments of the subject disclosure, there is provided a computer program comprising instructions, which, when executed by an apparatus for use in a first network node, cause the apparatus to perform generating a first multicast/broadcast session create or modification request indicating a first multicast/broadcast service area, transmitting the first multicast/broadcast session create or modification request to a second network node, receiving, from the second network node, a message including error information indicating that the first multicast/broadcast service area cannot be comprised within an area covered by a single multicast/broadcast session management function, generating a second multicast/broadcast session create or modification request with a reduced second service area compared to the first service area based on the error information, and transmitting the second multicast/broadcast session create or modification request to the second network node.

Additionally, according to some example embodiments of the subject disclosure, there is provided a computer program comprising instructions, which, when executed by an apparatus for use in a second network node, cause the apparatus to perform receiving a first multicast/broadcast session create or modification request generated by a first network node, evaluating a multicast/broadcast service area indicated in the first multicast/broadcast session create or modification request, if it is determined that the multicast/broadcast service area of the first multicast/broadcast session create or modification request cannot be comprised within an area covered by a single multicast/broadcast session management function, generating a message including error information indicating that the multicast/broadcast service area of the first multicast/broadcast session create or modification request cannot be comprised within the area covered by the single multicast/broadcast session management function, and transmitting the message with error information to the first network node.

The computer program product may comprise code means adapted to produce steps of any of the methods as described above when loaded into the memory of a computer.

According to some example embodiments of the subject disclosure, there is provided a computer program product as defined above, wherein the computer program product comprises a computer-readable medium on which the software code portions are stored.

According to some example embodiments of the subject disclosure, there is provided a computer program product as defined above, wherein the program is directly loadable into an internal memory of the processing device/apparatus.

According to some example embodiments of the subject disclosure, there is provided a computer readable medium storing a computer program as set out above.

According to some example embodiments of the subject disclosure, there is provided a computer program product comprising computer-executable computer program code which, when the program is run on a computer (e.g. a computer of an apparatus according to any one of the aforementioned apparatus-related example embodiments of the subject disclosure), is configured to cause the computer to carry out the method according to any one of the aforementioned method-related example embodiments of the subject disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Furthermore, some example embodiments of the subject disclosure may be implemented by an apparatus for use in a first network node comprising respective circuitry for performing the above-described processing.

That is, according to some example embodiments of the subject disclosure, there is provided an apparatus for use in a first network node, comprising generation circuitry for generating a first multicast/broadcast session create or modification request indicating a first multicast/broadcast service area, transmission circuitry for transmitting the first multicast/broadcast session create or modification request to a second network node, reception circuitry for receiving, from the second network node, a message including error information indicating that the first multicast/broadcast service area cannot be comprised within an area covered by a single multicast/broadcast session management function, generation circuitry for generating a second multicast/broadcast session create or modification request with a reduced second service area compared to the first service area based on the error information, and transmission circuitry for transmitting the second multicast/broadcast session create or modification request to the second network node.

Furthermore, some example embodiments of the subject disclosure may be implemented by an apparatus for use in a second network node comprising respective circuitry for performing the above-described processing.

That is, according to some example embodiments of the subject disclosure, there is provided an apparatus for use in a second network node, comprising reception circuitry for receiving a first multicast/broadcast session create or modification request generated by a first network node, evaluation circuitry for evaluating a multicast/broadcast service area indicated in the first multicast/broadcast session create or modification request, generation circuitry for generating, if it is determined that the multicast/broadcast service area of the first multicast/broadcast session create or modification request cannot be comprised within an area covered by a single multicast/broadcast session management function, a message including error information indicating that the multicast/broadcast service area of the first multicast/broadcast session create or modification request cannot be comprised within the area covered by the single multicast/broadcast session management function, and transmission circuitry for transmitting the message with error information to the first network node.

For further details regarding the functions of the apparatuses and the computer programs, reference is made to the above description of the methods according to some example embodiments of the subject disclosure, as described in connection with FIGS. 5 and 6.

In the foregoing description of the apparatus, only the units/means that are relevant for understanding the respective example embodiments have been described using functional blocks. The apparatus may comprise further units/means that are utilized for its respective operation, respectively. However, a description of these units/means is omitted in this specification. The arrangement of the functional blocks of the apparatus is not to be construed to limit any of the various example embodiments, and the functions may be performed by one block or further split into sub-blocks.

When in the foregoing description it is stated that the apparatus (or some other means) is configured to perform some function, this can alternatively be understood to disclose that a (i.e. at least one) processor or corresponding circuitry, potentially in cooperation with computer program code stored in the memory of the respective apparatus, is configured to cause the apparatus to perform at least the thus mentioned function. Also, such function may, in some example embodiments, be implementable by specifically configured circuitry or means for performing the respective function (e.g. the expression “unit configured to” is to be understood to alternatively disclose an expression such as “means for”).

As used herein, the term “circuitry” may refer to one or more or all of the following example embodiments:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (e.g., tangible, not a signal) as opposed to a limitation on data storage persistency (e.g., RAM vs. ROM).

As used herein, “at least one of the following:” and “at least one of” and similar wording, where the list of two or more elements are joined by “and” or “or”, mean at least any one of the elements, or at least any two or more of the elements, or at least all the elements.

For the purpose of the subject disclosure as described herein above, it should be noted that
method steps likely to be implemented as software code portions and being run using a processor at an apparatus (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the underlying concept of any example embodiment within the subject disclosure and its modification in terms of the functionality implemented;
method steps and/or devices, units or means likely to be implemented as hardware components at the above-defined apparatuses, or any module(s) thereof, (e.g., devices carrying out the functions of the apparatuses according to the aspects/embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components, APU (Accelerated Processor Unit), GPU (Graphics Processor Unit) or DSP (Digital Signal Processor) components;
devices, units or means (e.g. the above-defined apparatuses, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is noted that respective functional blocks or elements according to various example embodiments described herein can be implemented by any means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without the underlying concept of any example embodiment within the subject disclosure. Devices and means can be implemented as individual devices, but this does not exclude that they may be implemented in a distributed fashion throughout the system, as long as the described functionality can preserved.

Software in the sense of the various example embodiments of the subject disclosure comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is noted that the various example embodiments described herein are provided for illustrative purposes only and are in no way intended that the subject disclosure is restricted thereto. Rather, it is the intention that all variations and modifications which fall within the scope of the various example embodiment are covered.

1-18. (canceled)

19. An apparatus, comprising
at least one processor, and
at least one memory storing instructions that, when executed by the at least one processor, cause the apparatus at least to:
generate a first multicast/broadcast session create or modification request indicating a first multicast/broadcast service area,
transmit the first multicast/broadcast session create or modification request to a second network node,
receive, from the second network node, a message including error information indicating that the first multicast/broadcast service area cannot be comprised within an area covered by a single multicast/broadcast session management function,
generate a second multicast/broadcast session create or modification request with a reduced second service area compared to the first service area based on the error information, and
transmit the second multicast/broadcast session create or modification request to the second network node.

20. The apparatus according to claim 19, wherein
the error information comprises information about an acceptable multicast/broadcast service area.

21. The apparatus according to claim 20, wherein
the information about an acceptable multicast/broadcast service area comprises at least one of:
parts of the first multicast/broadcast service area covered by an area covered by a single multicast/broadcast session management function,
an area covered by a single multicast/broadcast session management function,
a list of areas, each covered by a single multicast/broadcast session management function, that together are covering the first multicast/broadcast service area, or
a list of areas, each covered by a single multicast/broadcast session management function, for all multicast/broadcast session management functions in a network.

22. The apparatus according to claim 19, wherein
the reduced second service area comprises an area that is covered by a single multicast/broadcast session management function.

23. The apparatus according to claim 19, wherein the instructions that, when executed by the at least one processor, cause the apparatus at least to:
generate a third multicast/broadcast session create request with a reduced third service area compared to the first service area based on the error information; and
transmit the third multicast/broadcast session create request to the second network function or a third network node.

24. The apparatus according to claim 23, wherein
the reduced third service area comprises an area that is covered by a single multicast/broadcast session management function.

25. The apparatus according to claim 23, wherein
the second multicast/broadcast session create or modification request and the third multicast/broadcast session create request comprise the same multicast/broadcast session identifier; and
the third multicast/broadcast session create request comprise an indication that the multicast/broadcast session is a location-dependent multicast/broadcast session; and
if the second multicast/broadcast session create or modification request is a create request, the second multicast/broadcast session create or modification request comprises an indication that the multicast/broadcast session is a location-dependent multicast/broadcast session.

26. The apparatus according to claim 23, wherein
the third network node is a network exposure function, a multicast/broadcast service function or a multicast/broadcast session management function.

27. The apparatus according to claim 19, further comprising:
sending data to at least one user equipment, which is located outside the area covered by the single multicast/broadcast session management function, via unicast delivery.

28. An apparatus, comprising
at least one processor, and
at least one memory storing instructions that, when executed by the at least one processor, cause the apparatus at least to:
receive a first multicast/broadcast session create or modification request generated by a first network node,
evaluate a multicast/broadcast service area indicated in the first multicast/broadcast session create or modification request,
if it is determined that the multicast/broadcast service area of the first multicast/broadcast session create or modification request cannot be comprised within an area covered by a single multicast/broadcast session management function, generate a message including error information indicating that the multicast/broadcast service area of the first multicast/broadcast session create or modification request cannot be comprised within the area covered by the single multicast/broadcast session management function, and
transmit the message with error information to the first network node.

29. The apparatus according to claim 28, wherein
the error information comprises information about an acceptable multicast/broadcast service area.

30. The apparatus according to claim 29, wherein
the information about an acceptable multicast/broadcast service area comprises at least one of:
the parts of the first multicast/broadcast service area covered by an area covered by the multicast/broadcast session management function,
the area covered by the multicast/broadcast session management function,
a list of areas, each covered by a single multicast/broadcast session management function, that together are covering the first multicast/broadcast service area, or
a list of areas, each covered by a single multicast/broadcast session management function, for all multicast/broadcast session management functions in a network.

31. The apparatus according to claim 28, wherein the instructions that, when executed by the at least one processor, cause the apparatus at least to:
request information about multicast/broadcast session management functions from a fourth network function, and
obtain information about at least one multicast/broadcast session management function from the fourth network function comprising for each multicast/broadcast session management function the area covered by the multicast/broadcast session management function.

32. The apparatus according to claim 31, wherein
the fourth network node is a network repository function.

33. The apparatus according to claim 28, wherein
the first network node is an application function.

34. A method, comprising:
generating a first multicast/broadcast session create or modification request indicating a first multicast/broadcast service area,
transmitting the first multicast/broadcast session create or modification request to a second network node,
receiving, from the second network node, a message including error information indicating that the first multicast/broadcast service area cannot be comprised within an area covered by a single multicast/broadcast session management function,
generating a second multicast/broadcast session create or modification request with a reduced second service area compared to the first service area based on the error information, and
transmitting the second multicast/broadcast session create or modification request to the second network node.

35. The method according to claim 34, wherein
the error information comprises information about an acceptable multicast/broadcast service area.
